(19) United States
(12) Patent Application Publication
(10) Pub. No.: US 2010/0129731 A1
(43) Pub. Date: May 27, 2010

(54) MULTI-WIRE, LONG-LIFE INTERCONNECTS FOR FUEL CELL STACKS

(75) Inventors: Sunil G. Warrier, Middletown, CT (US); Jean Yamanis, South Glastonbury, CT (US)

Correspondence Address: BACHMAN & LAPOINTE, P.C. (UTC), 900 CHAPEL STREET, SUITE 1201, NEW HAVEN, CT, 06510-2802, US

(73) Assignee: UTC POWER CORPORATION, South Windsor, CT (US)

(21) Appl. No.: 12/521,373

(22) PCT Filed: Dec. 28, 2006
(86) PCT No.: PCT/US06/49587

§ 371 Date: Sep. 22, 2009

(51) Int. Cl. H01M 8/02

(52) U.S. Cl. 429/507

(57) ABSTRACT

An interconnect assembly for a solid oxide fuel cell includes a porous interconnect comprising a plurality of first wires of a first material and at least one second material combined to form a first portion defining a separator plate contact zone and a second portion defining an electrode contact zone. Various wire weave shapes and pre-buckled architectures are shown such as FIG. 7 shows a substantially trapezoidal shaped cross-section where the cathode-side interconnect (30) comprises first wires (37).

### BACKGROUND OF THE INVENTION

The invention relates to solid oxide fuel cell (SOFC) stacks and, more particularly, to an interconnect that enhances the lifetime of SOFC stacks.

A fuel cell is a device which electrochemically reacts a fuel with an oxidant to generate a direct current. The fuel cell typically includes a cathode, an electrolyte and an anode, with the electrolyte being a non-porous material positioned between the cathode and anode materials. In order to achieve desired voltage levels, such fuel cells are typically connected in series using interconnects or bipolar plates to form a stack, or fuel cell stack, through which fuel fluid is passed past the anode electrode and oxidant fluid are passed past the cathode electrode. Electrochemical conversion takes place with the fuel being electrochemically oxidized by the oxidant to produce a DC electrical current.

The basic and most important requirements for the interconnect materials on the cathode side of a SOFC stack are sufficient oxidation and corrosion resistance in air at the stack operating temperatures; sufficient electron conductance; and close matching of thermal expansion behavior to that of the ceramic cell. In the case of metallic interconnects, the requirement of sufficient electron conductance is essentially equivalent to the electron conductance of the oxide scale that forms on the metal surface because the oxide scale tends to be the limiting resistance. Currently, the lack of stable, long-life (>40,000 hours), metallic interconnects for the cathode side of the stack, is a serious weakness of planar solid oxide fuel cells, because existing metal alloys cannot meet the thermal expansion, oxidation resistance, and electron conductance requirements simultaneously.

Cathode interconnect materials that have been used to date include perovskite-based ceramics, e.g., lanthanum chromite, high temperature chromium-based alloys or composites thereof, and nickel-based alloys or intermetallics have been used typically for cells operating in the 800-1000° C. range.

The prior art on ceramic-based interconnects such as doped lanthanum chromite indicates that this material exhibits both usable high temperature conductivity and thermal expansion behavior that matches the cell. However, this ceramic is very expensive, has low toughness and is difficult to manufacture as a suitable interconnect. Chromium-based interconnect materials have similar drawbacks.

Lower operating temperatures, e.g., 650° C.-800° C. with planar anode-supported cells, permit use of lower cost materials such as ferritic stainless steels that have a better coefficient of thermal expansion (CTE) match with the cell than Ni-based alloys. Commercial grades of ferritic steels may have suitable oxidation resistance at temperatures less than about 600° C. or for short lifetimes, but do not have the required oxidation resistance to last for 40,000 hours, or longer, due to the increasing ohmic resistance across the chromia oxide scale with time at operating temperatures greater than 700° C. that are typical for SOFC cell stacks based on zirconia-electrolyte.

The majority of prior art on these issues has attempted to prevent or ameliorate the degradation caused by oxide scale. Specifically, to take advantage of the lower cost and favorable CTE of ferritic steels, minor alloying additions and/or surface coatings have been researched to improve the oxidation resistance and conductivity. Certain elements such as manganese (Mn) appear beneficial in forming manganese chromite which increases the conductivity of the oxide scale, but more data is needed to determine whether both conductivity and oxidation resistance are sufficient for long-term applications. However, elements known to improve oxidation resistance, such as Al and Si, also tend to disadvantageously reduce the oxide conductivity and increase the CTE of the alloy. In Fe—Cr—Al—Y type steels, excellent oxidation performance is traded for the high resistivity of the resulting alumina film. Hence, the current state-of-the-art with regard to low cost Fe—Cr-based steels, has not fully resolved the long-term contact and oxidation issues.

Other materials, such as Ni—Cr or Ni—Cr—Fe-based alloys, while having good oxidation/corrosion resistance by design, typically have CTE values in the 15-18 parts per million (ppm)/° C. compared to the about 12 ppm/° C. of ferritic steels which better match the CTE of the ceramic cell.

Preferential removal of the oxide and/or coating/doping of the alloy surface with noble metals such as Ag, Au, Pt, Pd, and Rh has been used to mitigate conductivity loss by reducing oxygen diffusion into the contact points of the interconnect, but noble metals are too costly to use in power plants and commercial applications.

The oxidation resistance is clearly a concern on the cathode/oxidant side interconnect. However, the partial pressure of oxygen at the anode/fuel electrode may also be high enough to form Cr₂O₃ and the oxide may be even thicker (viz. the presence of electrochemically formed water) than on the cathode-side interconnect, so the resistivity of the interconnect may increase on both sides. The construction materials on the anode side of the interconnect could be the same as the cathode, although prior art has shown that, in the case of a ferritic steel interconnect in contact with a nickel anodic contact, weld points that formed between the steel and the nickel still formed a thin semiconducting oxide scale over time which degraded performance.

It is clear, from the above review of background art, that there remains a need for substantially improved interconnects between adjacent cells, whereby engineered materials provide long-term oxidation resistance and high electron conductance and in addition have the capability to minimize interface strains, caused by CTE mismatch during thermal cycling, are substantially eliminated by means of compliance while the interconnect geometry has sufficient creep resistance to ensure long-term durability.

### SUMMARY OF THE INVENTION

In one aspect of the present invention, an interconnect assembly for a solid oxide fuel cell broadly comprises a porous interconnect comprising a plurality of first wires of a first material and at least one second wire of a second material combined to form a first portion defining a separator plate contact zone and a second portion defining an electrode contact zone. The at least one second wire may broadly comprise a combination of at least one first wire of a first material and at least one second wire of a second material.

In another aspect of the present invention, a solid oxide fuel cell stack subassembly broadly comprises an electrode; a separator plate; and at least one porous interconnect comprising a plurality of first wires of a first material and at least one second wire of a second material combined to form a first portion defining a separator plate contact zone and a second portion defining an electrode contact zone, wherein the electrode is disposed in contact with the electrode contact zone and the separator plate is disposed in contact with the separator plate contact zone. The at least one second wire may broadly comprise a combination of at least one first wire of a first material and at least one second wire of a second material.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 schematically illustrates a partial view of a fuel cell stack assembly in accordance with the present invention;

FIG. 2A schematically illustrates a portion of a tailored wire weave comprising high-conductivity, no-scale wires in a one-dimensional array embedded in high-strength wires for the cathode-side interconnect;

FIG. 2B illustrates a portion of a tailored wire weave comprising high-conductivity, no-scale wires in a one-dimensional array embedded in high-strength wires for the anode-side interconnect;

FIG. 3A schematically illustrates a portion of a tailored wire weave comprising high-conductivity, no-scale wires in a two-dimensional array embedded in high-strength wires for the cathode-side interconnect;

FIG. 3B illustrates a portion of a tailored wire weave comprising high-conductivity, no-scale wires in a two-dimensional array embedded in high-strength wires for the anode-side interconnect;

FIG. 4A illustrates a portion of a tailored wire weave comprising pairs of a high-conductivity, no-scale and structural wires in a one-dimensional array embedded in high strength wires for the cathode-side interconnect;

FIG. 4B illustrates a portion of a tailored wire weave comprising pairs of high-conductivity, no-scale and structural wires in a one-dimensional array embedded in high strength wires for the anode-side interconnect;

FIG. 5A illustrates a portion of a tailored wire weave comprising pairs of high-conductivity, no-scale and structural wires in a two-dimensional array embedded in high strength wires for the cathode-side interconnect;

FIG. 5B illustrates a portion of a tailored wire weave comprising pairs of high-conductivity, no-scale and structural wires in a two-dimensional array embedded in high strength wires for the anode-side interconnect;

FIG. 6 illustrates a partial view of a rectangular channel corrugation of wire mesh shown in FIG. 2A that interconnects a surface of separator plate to the external surface of a cell cathode electrode;

FIG. 7 illustrates a partial view of a rectangular channel corrugation of wire mesh shown in FIG. 3A that interconnects a surface of separator plate to the external surface of a cell cathode electrode;

FIG. 8 illustrates a partial cross sectional view along a high-conductivity, no-scale wire of the wire mesh shown in FIG. 2A in a dovetail channel corrugation that interconnects a surface of separator plate to the external surface of a cell cathode electrode;

FIG. 9 illustrates a partial cross sectional view along a high-conductivity, no-scale wire of the wire mesh shown in FIG. 2A in a triangular channel corrugation that interconnects a surface of separator plate to the external surface of a cell cathode electrode.

Like reference numbers and designations in the various drawings indicate like elements.

### DETAILED DESCRIPTION

As used herein, the term “compliant superstructure” means an architecture having contours so as to define spaced contact zones for contacting a separator plate on one side and an electrode of a fuel cell on the other side.

As used herein, the term “compliant sub-structure” means a pre-buckled architecture composed of at least one alumina forming material and at least one chromia forming material.

As used herein, the term “compliant” means the inverse of the elastic modulus of the materials of the substructure in the in-plane direction.

As used herein, the term “pre-buckled” means crumpled, bent, heaved, warped or kinked in shape. These shapes may be achieved through wire weaving, die stamping, rolling, bending, combinations comprising at least one of the foregoing processes, and the like.

As used herein, the term “high-conductivity, no-scale metal” means a metal that does not form an insulating scale, e.g., alumina, or semiconducting scale, e.g., a chromia, oxide scale, having high electron conductivity relative to metals that do form insulating or semiconducting scale.

As used herein, the terms “tailored wire mesh”, “tailored wire fabric” “wire weave” and “co-weave” are considered synonymous terms.

As used herein, the terms “wire mesh”, “wire weave”, “wire cloth” and “wire fabric” are considered synonymous terms.

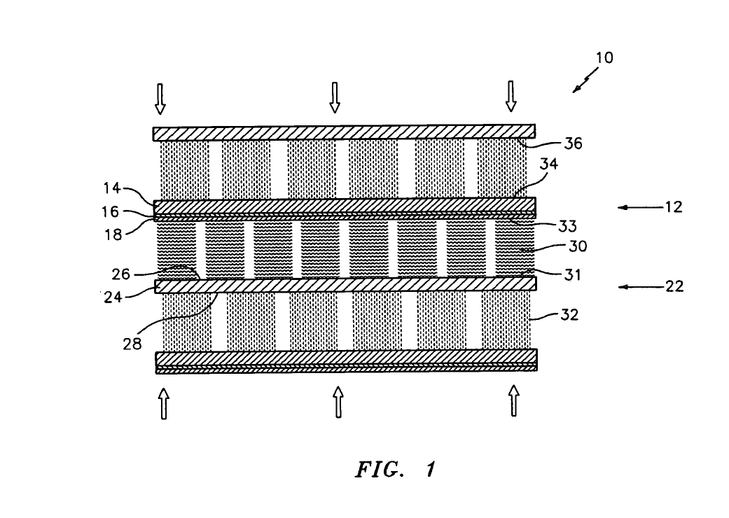

Referring to FIG. 1, an exemplary fuel cell stack assembly 10 is schematically illustrated. Assembly 10 may include a plurality of fuel cells 12 arranged in a stack with metal-based bipolar plates 22 positioned therebetween. Fuel cells 12 typically include an electrolyte 16, a cathode layer 18 positioned on one side of electrolyte 16, and an anode layer 14 positioned on the other side of electrolyte 16. Bonding or current carrying layers may be used between the cell electrodes and the interconnect surfaces adjacent to the cell electrodes.

Bipolar plates 22 generally include a metallic separator plate 24 having a cathode facing surface 26 and an anode facing surface 28, a metal-based cathode-side interconnect 30 positioned between cathode facing surface 26 and a cathode layer 18 of an adjacent fuel cell 12, and a metal-based anode-side interconnect 32 positioned between anode facing surface 28 and an anode layer 14 of an adjacent fuel cell 12. The cathode-side interconnect 30 may be formed to have a plurality of first portions 33 defining an electrode contact zone and a plurality of second portions 31 defining a separator plate contact zone which is spatially opposed from the electrode contact zone. The anode-side interconnect 32 may be formed to have a plurality of first portions 34 defining an electrode contact zone and a plurality of second portions 36 defining a separator plate contact zone which is spatially opposed from the electrode contact zone.

The cathode-side interconnect 30 or anode-side interconnect 32 or both may be configured to have a compliant structure in which case a compressive load is used appropriately to compress cell stack 10 so as to improve initial bonding of the stack layers and to provide robustness to vibration and thermal cycling.

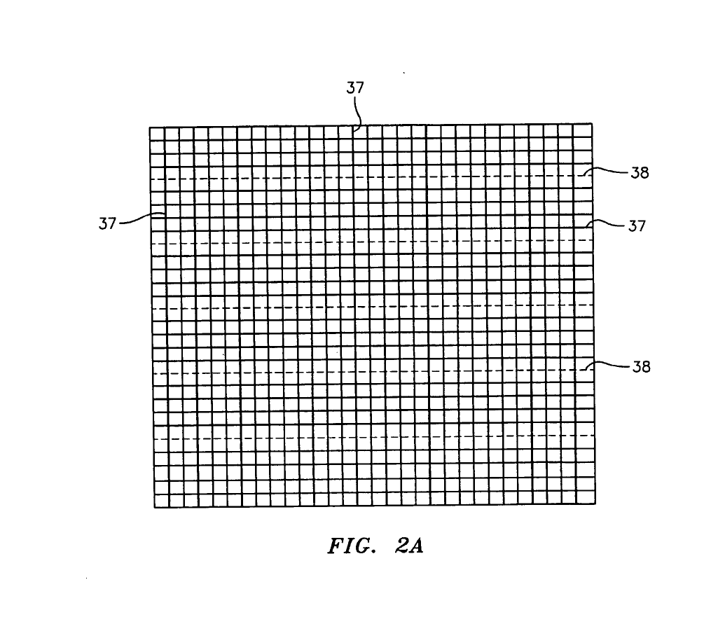

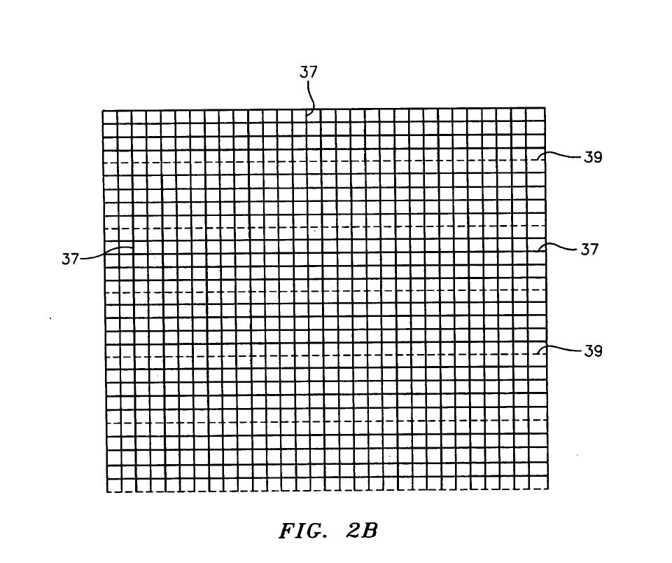

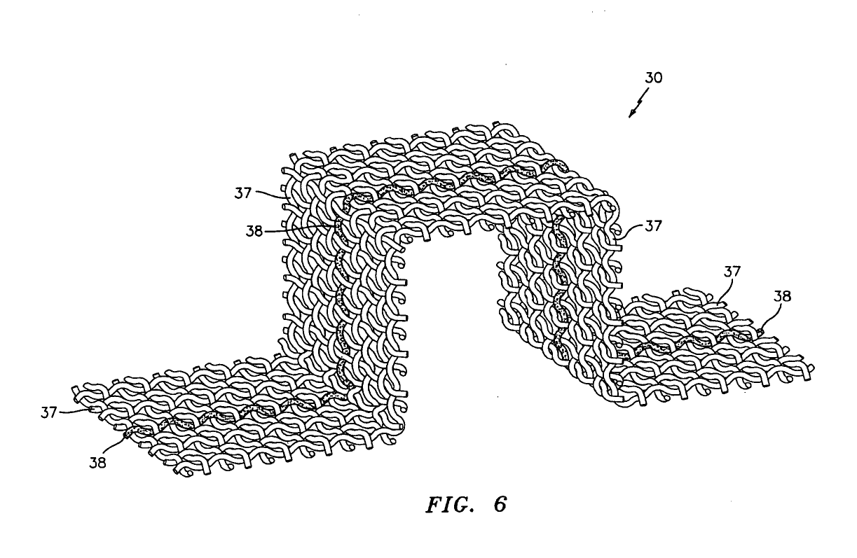

The exemplary cathode-side interconnects based on the exemplary tailored wire weaves shown in FIGS. 2A, 3A, 4A and/or 5A can be formed in a number of compliant geometries and in particular those shown in FIGS. 6-10 with the high-conductivity, no-scale wire being wire 38 selected from the metal group discussed herein. Compliant interconnect structures impart robustness to cell stack assemblies and mitigate potential thermal expansion mismatch between the cell 12 and the cathode-side interconnect 30. Furthermore, compliant interconnect structures enable cell stack assembly with cells of larger footprint and window-frame designs using parts of lesser dimensional precision and flatness and, thereby, can lead to cell stack assemblies of substantially lower cost per unit power.

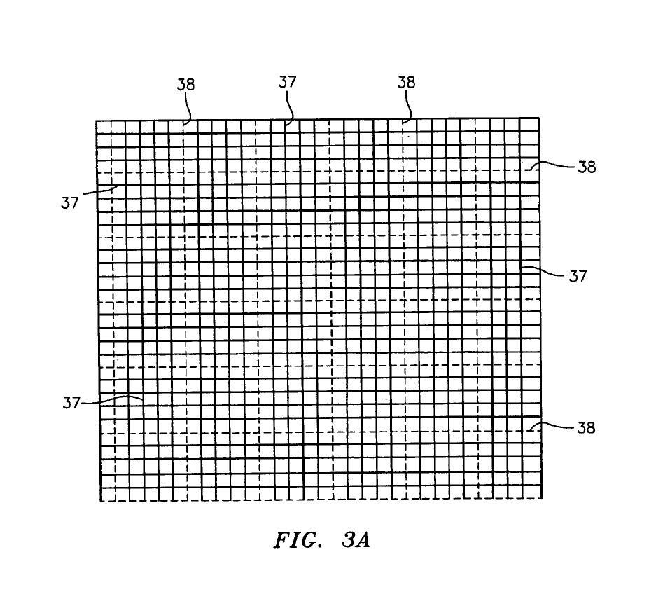

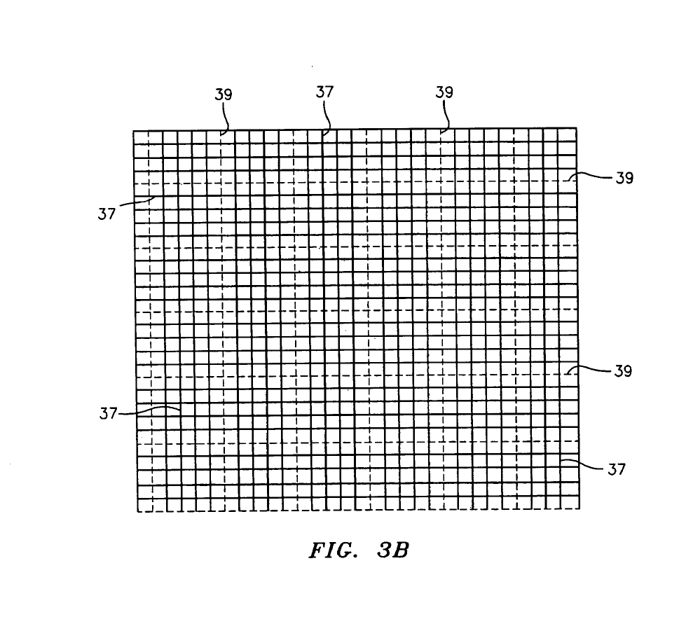

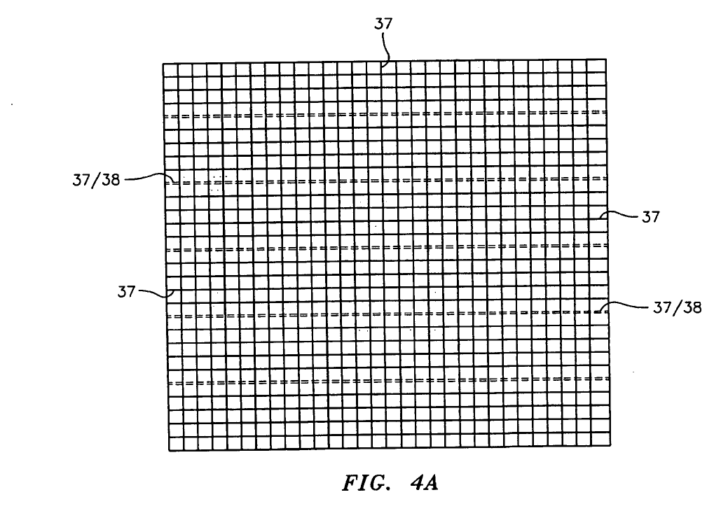

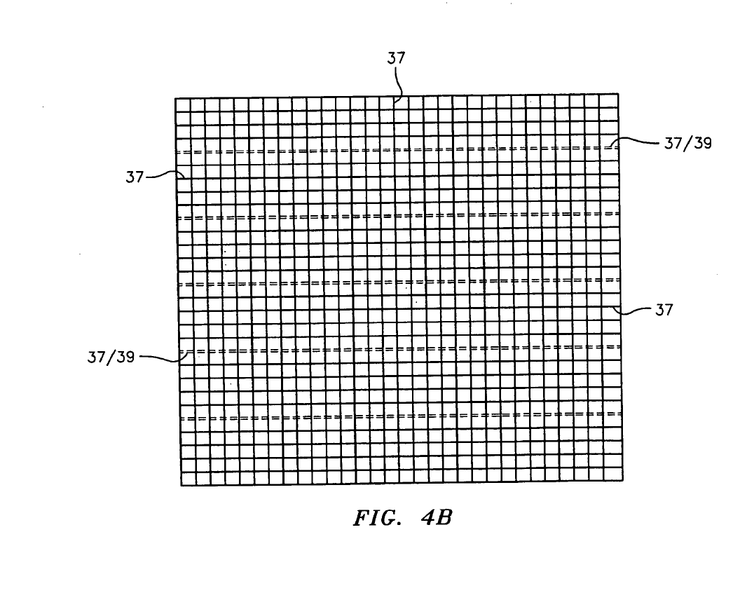

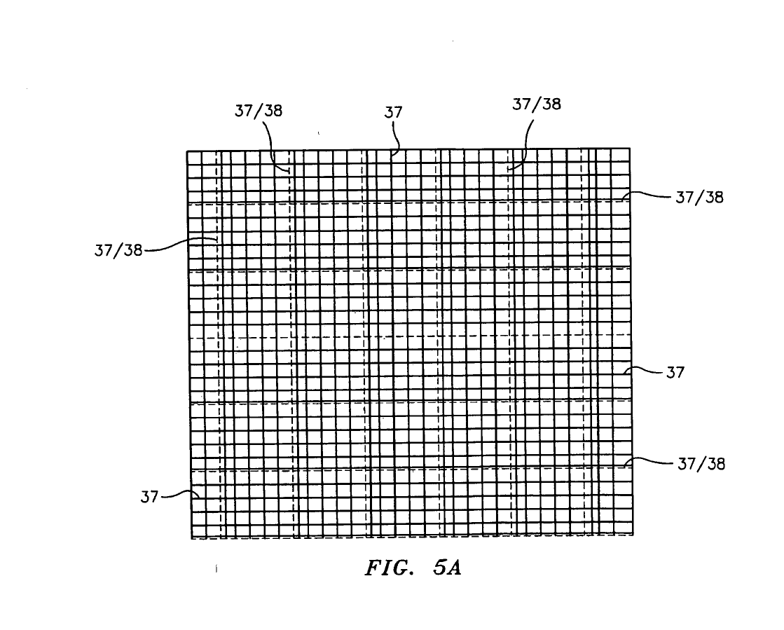

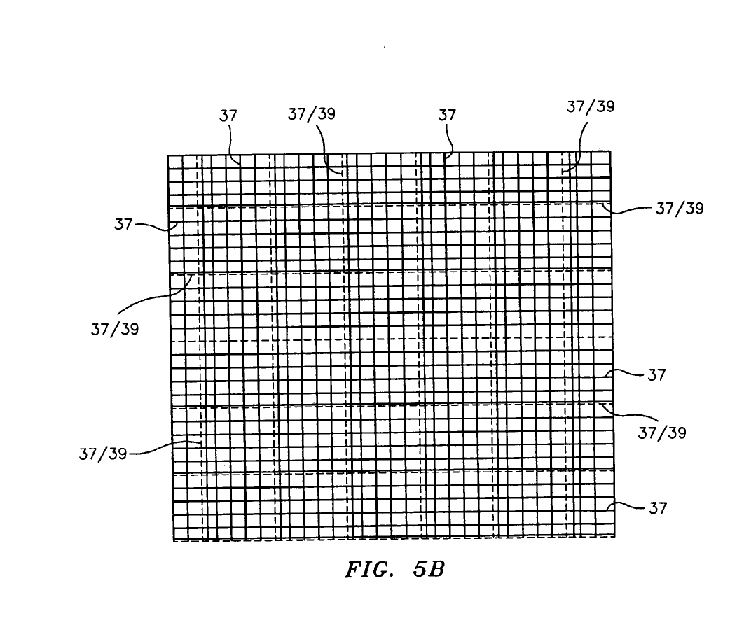

The cathode-side interconnect 30 may comprise a woven or braided fabric as illustrated in FIGS. 2A, 3A, 4A and 5A. A plurality of first wires 37 may be woven or braided together with at least one second wire 38 to form the cathode-side interconnect 30. For example, FIG. 2A shows a design in which the second wire 38 replaces the first wire 37 in the warp or weft direction and the replacement is every 5^{th} wire. This tailored wire fabric would be most suitable for use in any of the interconnect embodiments shown in FIGS. 6-10. FIG. 3A shows an alternative embodiment in which the at least one second wire 38 replaces every 5^{th} first wire 37 in both the warp and the weft directions. This tailored wire fabric of FIG. 3A would be most suitable for interconnect structures having a dimpled or egg-cartoon like geometry. In yet another alternative embodiment, the tailored wire weaves shown in FIGS. 4A and 5A may be used in interconnect structures similar to the aforementioned structures.

The plurality of first wires 37 may comprise an Al₂O₃-forming (also alumina-forming) alloy or a chromia-forming alloy. Alumina is an inert, dielectric material and as a result alumina-forming alloys cannot be used as current-conducting interconnects in SOFC, but their oxidation resistance and the chemical inertness of the alumina scale at stack operating temperatures makes them most suitable as the structural component in interconnect structures described herein. Suitable alumina-forming alloys include, but are not limited to, alloys having an aluminum content sufficient to develop alumina or alumina rich scales under the stack operating conditions, and may have an aluminum content of at least about 1.5 weight percent based upon the weight of the alloy. The alumina scale may form during the initial cell stack start up or during cell stack operation or its development may require pretreatment at other atmosphere and/or temperature conditions. Examples of alumina-forming alloys may include alumina-forming Ni-based superalloys such as Haynes® 214™, commercially available from Haynes International, Inc. of Kokomo, Ind.; Inconel 597, Nimonic 80A, Nimonic 90, Nimonic 105, Nimonic 115, and Nimonic 942, all commercially available from The Special Metals Corporation of Huntington, W.Va.; Astroloy, commercially available from Metso Minerals of York, Pa.; and, Cabot 214, commercially available from Cabot Corporation of Boyertown, Pa. Examples of alumina-forming alloys may also include alumina-forming stainless steels such as AK 18 SR, commercially available from AK Steel of Middletown, Ohio; Kanthal steel, commercially available from Kanthal Palm Coast of Palm Coast, Fla.; and, Aluchrom Y, commercially available from ThyssenKrupp VDM GmbH.

Chromia-forming alloys form a semiconducting oxide scale that becomes electron conducting at high temperatures. Chromia forming alloys may be extensively used in SOFC stacks to form the cathode-side interconnect as well as other components. Examples of chromia-forming alloys may include chromia-forming nickel-based alloys such as Haynes 230, commercially available from Haynes International, Inc. of Kokomo, Ind.; Inconel 718, commercially available from The Special Metals Corporation of Huntington, W.Va.; and the like. Examples of chromia-forming alloys may also include chromia-forming stainless steels such as E-BRITE, commercially available from Allegheny Ludlum Corporation of Pittsburgh, Pa., Crofer 22 APU, commercially available from ThyssenKrupp VDM GmbH, as well as chromium containing ferritic stainless steels and chromium containing superferritic stainless steels as known to one of ordinary skill in the art. However, the most notable drawback to using chromia-forming alloys is that oxidant environments tend to increase the thickness of the chromia oxide scale over time. In turn, the SOFC stack experiences an increasing ohmic loss due to the chromia scale. The increasing ohmic loss is directly proportional to the increasing chromia scale thickness leading to reduced electrochemical performance and energy conversion efficiency with time on stream.

When primarily utilizing alumina-forming alloys, at least one first wire 37 of the cathode-side interconnect 30 needs to be substituted using at least one second high-conductivity, no-scale wire 38 to fabricate cathode-side interconnects that lead to fuel cell stacks of high performance and high stability or durability. When primarily utilizing chromia-forming alloys, at least one first wire 37 of the cathode-side interconnect 30 may be substituted using at least one second high-conductivity, no-scale wire 38 to fabricate interconnects that lead to fuel cell stacks of high performance and high stability or durability. As described above, the at least one second wire 38 may be every N^{th} wire, where N is a positive integer. For example,.the N^{th} wire may be every 5^{th} wire such that for 100 wires, 80 wires may comprise the first material and the remaining 20 wires of the second material may be located at every 5^{th} wire across the interconnect structure. In a wire cloth configuration, the second wire 38 may be incorporated only in one direction, i.e., the warp or the weft direction as shown in FIG. 2A, or both in the warp and the weft directions as shown in FIG. 3A.

Alternatively, at least one of the first wire 37 of the cathode-side interconnect 30 may be combined with at least one second wire 38. In one exemplary embodiment, at least one first wire 37 and at least one second wire 38 may be parallel, that is, side-by-side to each other, and incorporated periodically in the warp or weft directions. The at least one first and second wire pair 37/38 may be placed every N^{th} wire position, where N is a positive integer. For example, the N^{th} wire may be every 5^{th} wire such that for 100 wires, 80 wires may comprise the first material and the remaining 20 wires of the second material may be located at every 5^{th} wire across the interconnect structure. The pairing of the first wire 37 and the second wire 38 may help mitigate potential issues with the wire weaving process that may arise from mechanical property mismatch between first wire 37 and second wire 38. The paired wires 37/38 may be incorporated only in one direction, i.e., the warp or the weft direction as shown in FIG. 4A, or in both the warp and the weft directions as shown in FIG. 5A. In another exemplary embodiment, a first wire 37 and a second wire 38 may be co-woven or braided together and incorporated periodically in the warp or weft directions. When utilizing a co-woven or braided wire 37/38, the increased diameter of the combined wires 37/38 will increase the overall thickness of the interconnect structure. As a result, each wire 37 and 38 may have a smaller diameter so that the overall thickness of the interconnect structure does not exceed its useful operating parameters.

The material for the second wire 38 of the cathode-side interconnect may be selected from the group comprising silver (Ag), gold (Au), platinum (Pt), palladium (Pd), rhodium (Rh), iridium (Ir) and combinations thereof, and the like, or the material may be composed of pure silver or a silver-rich alloy, and the like. In the air or oxidant environment of the cathode compartment and selected temperature ranges, all of the aforementioned materials for the second wires 38 do not form any oxide scale and, as a result, have high electronic conductivity. These metals when used in the air or oxidant environment are referred to as high-conductivity, no-scale materials. Most of these metals have high thermal expansion coefficient (CTE) and may only be used as coatings or thin gauge geometries bonded to the separator plate. With the exception of silver, most noble metals are very expensive and can only be used in very thin coatings if at all. These materials also have low strength and creep resistance at the SOFC operating temperatures. As a result, these materials alone cannot be formed into compliant structures that are robust to thermal cycling and could mitigate the CTE mismatch. However, the high-conductivity, no-scale materials of wire 38 may be combined with the structural materials of wires 37 that provide strength and creep resistance to form the exemplary tailored wire weave structures described herein. The high-conductivity, no-scale material wires 38 provide low resistance to electron flow from cell to cell and impart very long lifetime and stability to the electrochemical performance, i.e., stable ohmic loses, for the fuel cell stack since these materials are stable in their metallic form in the air environment.

As described herein, the chromia-forming alloys can contribute to the increased resistance and ohmic loss experienced by the interconnect assemblies due to increasing chromia scale thickness. Another concern is chromia poisoning and, in turn, SOFC contamination. Chromia scales can also form hexavalent chemical species which may volatilize and be transported to the cathode electrode or the electrolyte/cathode electrode interface and form chromia deposits. Chromia deposition may ultimately impair the electrochemical performance of the SOFC. Alternatively, the chromia scale may locally react with the cathode electrode yielding chemical compositions that in turn reduce electrochemical activity and SOFC electrochemical performance. For this reason, measures are typically taken to suitably coat, apply masking coatings to, alter the composition of, or use contact materials disposed upon chromia forming materials to eliminate or substantially reduce chromia poisoning effects. When forming the exemplary interconnect assemblies described herein using chromium and aluminum-containing alloys, these alloys must be heat-treated in special atmospheres and temperatures in order to preferentially develop the alumina scale. For example, the special atmosphere may be a hydrogen atmosphere having an oxygen content corresponding to a dew point of approximately −34° C. to develop a substantially pure alumina scale instead of chromia or chromia-alumina scale. The so-formed alumina scale mitigates the potential for the said chromia poisoning to occur.

In all of the exemplary interconnect assembly embodiments described herein, the use of alumina-forming alloys as the structural wire 37 mitigates chromia poisoning while the use of high electronic conductivity, no-scale materials for wire 38 eliminates the increasing ohmic resistance and losses arising from using chromia-forming alloys. This combination of alumina-forming and no-scale materials using the tailored wire fabrics described herein as the interconnect ensures that the exemplary interconnect assemblies described herein possess: longevity and stable electrochemical performance, i.e., stable voltage at constant current, over long periods of time.

The area specific resistance across the cathode-side interconnect and its interfaces needs to be minimized and designed to be less than about 0.2 Ω.cm², or less than about 0:10 Ω.cm², or less than about 0.05 Ω.cm².

The area specific resistance may be related to the incorporation of the second wire material with the first wire material in the exemplary interconnect structures. The factors influencing the determination of the N^{th} wire or the frequency or pitch or spacing of structural wire 37 replacement by high-conductivity, no-scale wire 38 for the cathode-side interconnect 30 is chosen so as to minimize ohmic losses to current flow across the interconnect and the interconnect/separator plate interfaces. Assuming the wire diameter, wire weave, and mesh size, i.e., the number of wires per inch, are known for achieving a given area specific resistance with, e.g., Haynes 230 as the material for wire 37, then the replacement frequency “every N^{th}” wire can be approximated as the ratio of the resistivity of Haynes 230 over the resistivity of the high-conductivity, no-scale wire. These ratios are shown in Table 1 provided below. The high-conductivity, no-scale wire materials for the cathode-side interconnect may be the aforementioned noble metals such as Ag or Ag-rich alloys, on a cost-basis as has been discussed herein. The resistivity ratio for Ag is 21.2. This means that in tailored wire weaves with Haynes 230 as the structural wire and Ag replacing every 21^{st} wire of Haynes 230 will result in a cathode-side interconnect that has the same area specific resistance as a pristine, i.e., not oxidized, cathode-side interconnect composed of only Haynes 230 wires. The tailored Haynes 230/Ag weave with the aforementioned replacement frequencies will remain at the initial area specific resistance in the air or oxidant environment even after a very long period of time because Ag does not oxidize in the oxidizing environment of the cathode gas space. In contrast, the area specific resistance of a cathode-side interconnect based solely on Haynes 230 wires would begin to increase from the moment the interconnect enters service due to the development of chromia scale which has high resistivity as indicated in Table 1. This data clearly illustrates the real and excellent potential of the exemplary tailored wire weaves described herein.

TABLE 1

| | Resistivity @ 700° C. | Resistivity ratio @ |
|---|---|---|
| Metal/Alloy/Ceramic | (μOhm · cm) | 700° C. (H230/X) |
| H230 | 130.7 | 1.0 |
| SS446 | 119.0 | 1.1 |
| Ni | 38.8 | 3.4 |
| Cu | 6.6 | 19.7 |
| Pt | 38.8 | 3.4 |
| Pd | 41.6 | 3.1 |
| Au | 8.2 | 16.0 |
| Ag | 6.2 | 21.2 |
| Cr₂O₃ | 646507070.0 | — |

In the example described above, replacing every 21^{st} wire of Haynes 230 with an Ag wire may be sufficient to achieve the desired ohmic resistance for the interconnect structure. However, the proposed replacement may not be sufficient to achieve the ohmic resistance requirement for the interconnect and interconnect/cathode electrode. For example, in a tailored wire weave having a square pattern with a 60 mesh, i.e., 60 wires per inch, one may replace the 21^{st} structural wire 37 with a high-conductivity, no-scale wire 38. However, the wire 38 will be have approximately 0.35 inches (9 millimeters) distance from each wire 37 on either side, which is too large a distance. The lateral resistivity of the cathode electrode is not great enough to compensate for this distance between wires 37 and 38. As a result, the lateral resistivity of the cathode electrode becomes the controlling resistance of the interconnect/cathode electrode and requires a greater number of wires 38 to be incorporated into the interconnect structure. For example, every 5^{th} wire 37 of Haynes 230 would be replaced with the high-conductivity, no-scale wire 38 in order to meet the area specific resistance requirement for the fuel cell stack, apart from the electrolyte resistance.

As discussed herein, other factors do come into play in determining the optimal frequency of replacing structural wire 37 with the high-conductivity, no-scale wire 38. The most important one being the lateral or in-plane electronic conductivity of the cathode electrode and the bonding materials and the bonding layer thickness employed when bonding the interconnect to the cathode electrode. Other factors such as the diameter of the first/second wires 37/38, the wire weave pattern, and the like, may affect the optimal replacement frequency of wires 37 with wires 38. All of these factors may require that the high-conductivity Ag and Ag-alloy wires be placed closer together than the aforementioned resistivity ratio indicates in order to minimize undue ohmic losses in the lateral direction, and optimize the overall area specific resistance for the cell stack excluding the contribution from the cell electrolyte resistance. Similar considerations and guidelines may apply to the replacement frequency of the structural wire 37 with respect to at least one second wire 39 when considering the anode interconnect 32 as will be described herein.

The wire diameter and mesh of the exemplary tailored wire weaves may be chosen to meet structural as well as the electronic requirements of the both the cathode-side and anode-side interconnects 30, 32 for the solid oxide fuel cell stack design. Generally, the wire diameters may be greater than about 0.003 inches (0.075 mm) and less than about 0.05 inches (2 mm). The mesh of the wire weave may be greater than 5 wires per inch, and greater than 20 wires per inch, and less than 100 wires per inch.

Due to the amount of separation, additional Haynes 230 or other structural wires 37 may be substituted using silver or silver-rich alloy wires in order to maintain the desired amount of contact with the cathode. These factors as well as diameter of the first/second wires, the wire weave pattern, the bonding materials as well as other factors may affect the optimal replacement frequency.

Lastly, the plurality of first wires 37 and the second wires 38 of cathode-side interconnect 30 may have a wire diameter of between about 0.05 mm and about 1 mm, or between about 0.1 mm and about 0.4 mm; a weave pitch in wires per unit length of between 1 wire/5 mm and 5 wires/1 mm, or between 1 wire/1 mm and 3 wires/1 mm; a weave pattern which may be square, plain, satin, twill, Dutch, or other patterns as is known to one of ordinary skill in the art; and, a weave periodicity which may be uniform or random.

Referring now to FIGS. 2B, 3B, 4B, and 5B, the anode-side interconnect may comprise substantially the same structural features, physical properties, operating parameters and materials as the cathode-side interconnect with the exception of the following difference. The anode-side interconnect may utilize a different set of materials for at least one second wire 39 in the wire weave anode-side interconnect structures.

The material for at least one second wire 39 of the anode-side interconnect may be selected from the group comprising nickel (Ni), copper (Cu), Ni—Cu alloys, silver (Ag), gold (Au), platinum (Pt), palladium (Pd), rhodium (Rh), iridium (Ir) and combinations thereof, and other ductile materials or metals that do not form an electrically insulating scale in a hydrogen-carbon monoxide-water vapor atmospheres. In the fuel environment of the anode compartment all the aforementioned materials of the second wire 39 do not form any oxide scale and as a result have high electronic conductivity. These metals when used in the fuel environment are referred to as high-conductivity, no-scale materials. These metals have high thermal expansion coefficient (CTE) and as a result they can only be used as coatings or thin gauge geometries bonded to the separator plate. These materials also have low strength and creep resistance at the SOFC operating temperatures cannot be formed into compliant structures that could mitigate the CTE mismatch and lead to structures that are robust to thermal cycling. However, the high-conductivity, no-scale materials of wire 39 may be combined with the structural materials of wires 37 that provide strength and creep resistance to form the exemplary tailored wire weave structures described herein. The high-conductivity, no-scale material wires 38 provide low resistance to electron flow from cell to cell and impart very long lifetime and stability to the electrochemical performance, i.e., stable ohmic loses, for the fuel cell stack since these materials are stable in their metallic form in the fuel environment.

Due to the amount of separation between wires within the anode-side interconnect 32, additional structural first wires 37 may be substituted using second wires 39, such as nickel, copper or silver wires, in order to maintain the desired amount of contact with the anode electrode and minimize the area specific resistance of the interconnect and interconnect/anode electrode interface. These factors as well as diameter of the first/second wires, the wire weave pattern, the bonding or contact materials may affect the optimal replacement frequency.

The cathode-side interconnect 30 and anode-side interconnect 32 may be attached to the metallic separator plate by means of brazing, welding, spot welding, seam welding, laser welding, electron-beam welding and similar processes known in the art. The joining processes establish a metallurgical bond across the joint and with proper selection of metallic materials remains so bonded during sufficiently long service at the elevated, SOFC operating temperatures.

In another exemplary embodiment, the cathode-side interconnects 30 and anode-side interconnects 32 based on the exemplary tailored wire weaves shown in FIGS. 2A-5B may either be bonded to a flat separator plate or an engineered separator plate. When using an engineered separator plate, the wire mesh interconnect structure may not have a compliant structure; thus, the plurality of first wires 37 for either interconnect 30, 32 may not necessarily need to meet stringent strength and creep resistance requirements for SOFC use.

In yet another exemplary embodiment, the Al₂O₃-forming alloy wires of either the cathode-side interconnect 30, anode-side interconnect 32, or both interconnects 30, 32 may also be coated with a material preferably selected from a group of materials that promote electrical conductivity and also have sufficient long-term oxidation resistance at the stack operating temperatures. The coating preferably prevents oxidation of the wire mesh interconnect while the interconnect material provides the strength and creep resistance that matches the deformation and compliance of both the cathode-side interconnect 30 and anode-side interconnect 32. For the cathode-side interconnect, suitable coating materials include, but are not limited to, silver, cobalt, ruthenium, gold, platinum, palladium, iridium, rhodium, and mixtures thereof. For the anode-side interconnect, suitable coating materials include, but are not limited to, nickel, copper, nickel-copper alloys, silver, cobalt, ruthenium, gold, platinum, palladium, iridium, rhodium, and mixtures thereof as well as other ductile materials or metals that do not form an electrically insulating scale in a hydrogen-carbon monoxide-water vapor atmospheres. The coating may be applied to the Al₂O₃-forming alloy wire mesh prior to being woven (e.g., wires), after being woven (e.g., compliant interconnect substructure) or after fabricating the compliant superstructure using any one of a number of methods known to one of ordinary skill in the art. The coating may also be applied to substantially cover the entire surface of the wires or a surface of the compliant interconnect substructure, e.g., the cathode/compliant superstructure interface or the compliant interconnect superstructure/separator plate interface.

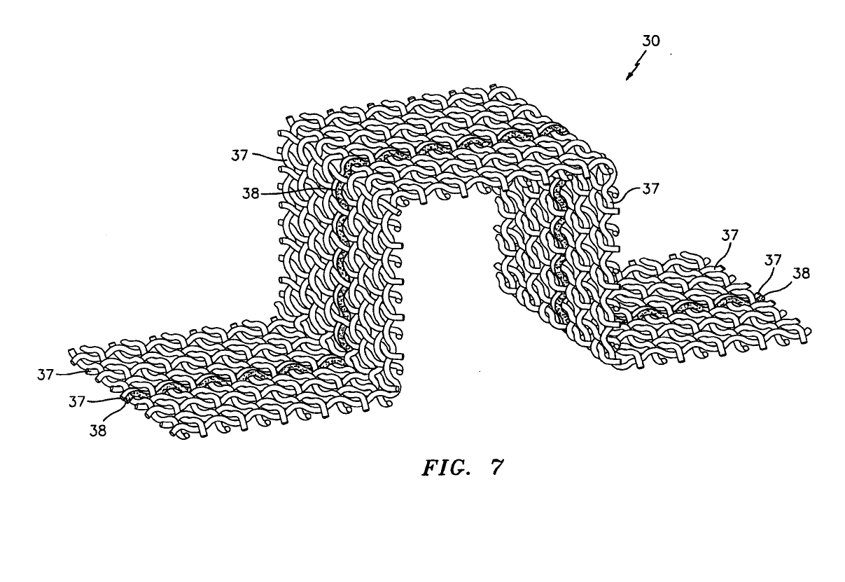

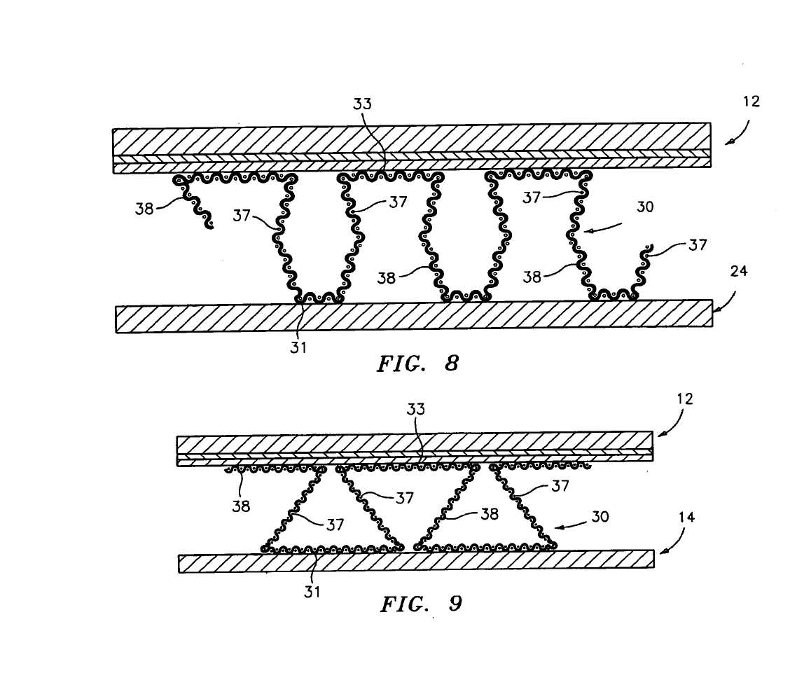

The figures illustrate various wire weave shapes and pre-buckled architectures such as a substantially sinusoidal shaped cross-section (FIGS. 3-5); substantially orthogonal shaped cross-section, e.g., square, rectangular channel patterns (FIG. 6); substantially trapezoidal shaped cross-section (FIG. 7); substantially circular or helical shaped cross-section (FIG. 8); and, substantially hour-glass shaped cross-section (FIG. 9).

The aforementioned cathode-side interconnect 30 and anode-side interconnect 32 are provided as a wire weave as illustrated in FIGS. 1-9 having a pre-buckled architecture that increases the compliance of interconnects 30, 32. This compliance facilitates the movement or deflection of interconnects 30, 32 without stressing the first portions 34 relative to the second portions 36 during long-term creep, thermal cycling and other stack operating conditions, which serve to eliminate stresses caused by CTE mismatch between various cell stack components.

Clearly, those skilled in the art will realize that a large number of patterns and arrangements of such compliant sub-structures as well as superstructures exist, and are all within the broad scope of the exemplary embodiments described herein.

The separator plate 24 can be bonded to cathode-side interconnect 30 and anode-side interconnect 32 through various methods to produce high-strength interfaces therebetween. For example, such joints or components can be bonded, welded or brazed together, or can be secured together in other manners which would be well known to a person of ordinary skill in the art. Furthermore, it may be contemplated to position these components adjacent to each other without any bonding therebetween.

The wire weave sub-structure and three-dimensional superstructure of the exemplary cathode-side and anode-side interconnects 30, 32 described herein serve to alleviate stresses at the anode and cathode interfaces, and minimizes fracture of the interface and the cells themselves.

The compliant interconnects described herein are designed such that high values of both in-plane and out-of-plane compliance are achieved. One skilled in the art will recognize that any such interconnect that provides for acceptable levels of either in-plane compliance or out-of-plane compliance, or both, will be within the broad scope of the invention. Preferably, the compliant superstructure is compliant in at least three orthogonal axes, and is compliant with respect to a load applied from any direction.

Interconnect compliance values may be about 5×10 mm²/N (in strain/stress units) and higher at room temperature, or about 5×10 mm²/N and higher, or about 5×10⁻² mm²/N and higher. One of ordinary skill in the art will recognize that other compliancy values can be acceptable and are within the scope of the invention.

It should be noted that a significant parameter is the response of the interconnect and seal to the clamping compressive load which must be applied to the fuel cell stack as schematically illustrated in FIG. 1.

FIG. 1 also illustrates a compressive load applied to the top and bottom of assembly 10. The compressive load is selected to provide for sufficient interconnect contact or bonding with the cell electrode and sufficiently reduced leakage with compliant seals while nevertheless, allowing micro-sliding in the seal area to relieve thermal mismatch stresses and to minimize compressive creep of the interconnects. From a manufacturing standpoint, the exemplary system(s) described herein provides for cells and interconnects having less stringent dimensional tolerances since interconnects provide out-of-plane compliance and, therefore, increased dimensional freedom.

It should of course be appreciated that an interconnect superstructure and compliant seal assembly have been provided which allow for reduced stringency in tolerances in manufacture and assembly of solid oxide fuel cell stacks, and further reduce the stresses conveyed between various components of the stack, thereby decoupling different design concerns of the stack and allowing selection of materials to provide long stack life and robustness to thermal cycling.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope.

What is claimed is:

1. An interconnect assembly for a solid oxide fuel cell, comprising:
a porous interconnect comprising a plurality of first wires of a first material and at least one second wire of a second material combined to form a first portion defining a separator plate contact zone and a second portion defining an electrode contact zone.

2. The interconnect assembly of claim 1, wherein said second material is a high-conductivity, no-scale forming material.

3. The interconnect assembly of claim 1, wherein said at least one second wire comprises a pair of wires, wherein said pair of wires comprise a wire of said first material and a wire of said second material.

4. The interconnect assembly of claim 3, wherein said pair of wires are disposed parallel to each other.

5. The interconnect assembly of claim 1, wherein said porous interconnect comprises a porous cathode-side interconnect.

6. The interconnect assembly of claim 5, wherein said porous interconnect comprises a weave of said first wires and said at least one second wire.

7. The interconnect assembly of claim 6, wherein one out of every N^{th} first wire is substituted with said at least one second wire, and N is a positive integer.

8. The interconnect assembly of claim 6, wherein one out of every N^{th} first wire is substituted with a pair of wires, wherein said pair comprises a first wire and a second wire, and N is a positive integer.

9. The interconnect assembly of claim 8, wherein said pair of wires are disposed parallel to each other.

10. The interconnect assembly of claim 6, wherein said first material comprises an alumina-forming alloy or a chromia-forming alloy.

11. The interconnect assembly of claim 10, wherein said first material is an alumina-forming alloy.

12. The interconnect assembly of claim 6, wherein said second material comprises a high-conductivity, no-scale forming material.

13. The interconnect assembly of claim 12, wherein said second material comprises at least one of the following materials: silver, gold, platinum, palladium, rhodium, iridium, and combinations thereof.

14. The interconnect assembly of claim 1, wherein said porous interconnect comprises a porous anode-side interconnect.

15. The interconnect assembly of claim 14, wherein said porous interconnect comprises a weave of said first wires and said at least one second wire.

16. The interconnect assembly of claim 15, wherein one out of every N^{th} first wire is substituted with said at least one second wire, and N is a positive integer.

17. The interconnect assembly of claim 14, wherein one out of every N^{th} first wire is substituted with a pair of wires, wherein said pair comprises a first wire and a second wire, and N is a positive integer.

18. The interconnect assembly of claim 17, wherein said pair of wires are disposed parallel to each other.

19. The interconnect assembly of claim 15, wherein said first material comprises an alumina-forming alloy or a chromia-forming alloy.

20. The interconnect assembly of claim 14, wherein said first material is an alumina-forming alloy.

21. The interconnect assembly of claim 14, wherein said second material comprises a high-conductivity, no-scale forming material.

22. The interconnect assembly of claim 21, wherein said second material comprises at least one of the following materials: nickel, copper, nickel-copper alloy, silver, gold, platinum, palladium, rhodium, iridium, and combinations thereof.

23. The interconnect assembly of claim 1, wherein said plurality of first wires and said at least one second wire are woven or braided together.

24. The interconnect assembly of claim 23, wherein said plurality of first wires and said at least one second wire are pre-buckled using at least one process comprising: wire weaving, crumpling, bending, heaving, warping, kinking, die stamping, and rolling.

25. The interconnect assembly of claim 1, wherein said first plurality of first wires comprise a coating comprising a metal selected from the group consisting of nickel, copper, silver, cobalt, ruthenium, gold, platinum, palladium, nickel-copper alloys, and mixtures thereof.

26. The interconnect assembly of claim 1, wherein said plurality of first wires and said at least one second wire combine to form at least one pattern and at least one shape.

27. The interconnect assembly of claim 1, wherein said interconnect assembly further comprises a cross-section comprising one of the following shapes: substantially sinusoidal, substantially orthogonal, substantially trapezoidal, substantially circular, substantially helical, substantially hour-glass, substantially triangular, and substantially prismatic.

28. A solid oxide fuel cell stack subassembly comprising:
an electrode;
a separator plate; and
at least one porous interconnect comprising a plurality of first wires of a first material and at least one second wire of a second material combined to form a first portion defining a separator plate contact zone and a second portion defining an electrode contact zone,
wherein said electrode is disposed in contact with said electrode contact zone and said separator plate is disposed in contact with said separator plate contact zone.

29. The stack subassembly of claim 28, wherein said second material is a high-conductivity, no-scale forming material.

30. The stack subassembly of claim 28, wherein said at least one second wire comprises a pair of wires, wherein said pair of wires comprise a wire of said first material and a wire of said second material.

31. The stack subassembly of claim 28, wherein said pair of wires are disposed parallel to each other.

32. The stack subassembly of claim 28, wherein said porous interconnect comprises a porous cathode-side interconnect.

33. The interconnect assembly of claim 32, wherein said porous interconnect comprises a weave of first wires and said at least one second wire.

34. The stack subassembly of claim 33, wherein one out of every N^{th} first wire is substituted with said at least one second wire, and N is a positive integer.

35. The stack subassembly of claim 33, wherein one out of every N^{th} first wire is substituted with a pair of wires, wherein said pair comprises a first wire and a second wire, and N is a positive integer.

36. The stack subassembly of claim 35, wherein said pair of wires comprises are disposed parallel to each other.

37. The stack subassembly of claim 32, wherein said first material comprises an alumina-forming alloy or a chromia-forming alloy.

38. The stack subassembly of claim 37, wherein said first material is an alumina-forming alloy.

39. The stack subassembly of claim 32, wherein said second material comprises a high-conductivity, no-scale forming material.

40. The stack subassembly of claim 39, wherein said second material comprises at least one of the following materials: silver, gold, platinum, palladium, rhodium, iridium, and combinations thereof.

41. The stack subassembly of claim 28, wherein said porous interconnect comprises a porous anode-side interconnect.

42. The stack subassembly of claim 28, wherein said porous interconnect comprises a weave of said first wires and said at least one second wire.

43. The stack subassembly of claim 42, wherein one out of every N^{th} first wire is substituted with said at least one second wire, and N is a positive integer.

44. The stack subassembly of claim 33, wherein one out of every N^{th} first wire is substituted a pair of wires, wherein said pair comprises a first wire and a second wire, and N is a positive integer.

45. The stack subassembly of claim 44, wherein said pair of wires are disposed parallel to each other.

46. The stack subassembly of claim 42, wherein said first material comprises an alumina-forming alloy or a chromia-forming alloy.

47. The stack subassembly of claim 42, wherein said first material is an alumina-forming alloy.

48. The stack subassembly of claim 41, wherein said second material comprises a high-conductivity, no-scale forming material.

49. The stack subassembly of claim 48, wherein said second material comprises at least one of the following materials: nickel, copper, nickel-copper alloy, silver, gold, platinum, palladium, rhodium, iridium, and combinations thereof.

50. The stack subassembly of claim 28, wherein said plurality of first wires and said at least one second wire are woven or braided together.

51. The stack subassembly of claim 50, wherein said plurality of first wires and said at least one second wire are pre-buckled using at least one process comprising: wire weaving, crumpling, bending, heaving, warping, kinking, die stamping, and rolling.

52. The stack subassembly of claim 28, wherein said first plurality of first wires comprise a coating comprising a metal selected from the group consisting of nickel, copper, silver, cobalt, ruthenium, gold, platinum, palladium, nickel-copper alloys, and mixtures thereof.

53. The stack subassembly of claim 28, wherein said plurality of first wires and said at least one second wire combine to form at least one pattern and at least one shape.

54. The stack subassembly of claim 28, wherein said interconnect assembly further comprises a cross-section comprising one of the following shapes: substantially sinusoidal, substantially orthogonal, substantially trapezoidal, substantially circular, substantially helical, substantially hour-glass, substantially triangular, and substantially prismatic.
